(19) United States
(12) Patent Application Publication
(10) Pub. No.: US 2010/0203925 A1
(43) Pub. Date: Aug. 12, 2010

(54) MOBILE COMMUNICATION TERMINAL, INPUT OPERATION SCREEN CONTROL METHOD USED FOR THE SAME, AND PROGRAM THEREOF

(76) Inventor: Michio Nagai, Tokyo (JP)

Correspondence Address: Mr. Jackson Chen, 6535 N. STATE HWY 161, IRVING, TX, 75039, US

(21) Appl. No.: 12/670,839

(22) PCT Filed: Aug. 5, 2008
(86) PCT No.: PCT/JP2008/064067

§ 371 Date: Jan. 26, 2010

(30) Foreign Application Priority Data
Aug. 8, 2007 (JP) 2007-206015

(51) Int. Cl. G06F 3/01; H04M 1/02

(52) U.S. Cl. 455/566; 345/156

(57) ABSTRACT

Provided is a mobile communication terminal which can effectively improve user's operability. A mobile communication terminal (1) which can perform radio communication includes: an upper unit formed by a first display member (display unit (19)) and a first support member having a rotary mechanism which connects the first display member electrically and structurally; and a lower unit formed by a second display member (display/input unit (20)) and a second support member having a rotary mechanism which connects the second display member electrically and structurally. The mobile communication terminal (1) includes open/close detection means (open/close sensor (22)) which detects the open/close state between the upper unit and the lower unit; rotation detection means (rotation sensor (23)) which detects the rotation state of the first and the second display member; and control means (control unit (26)) which controls a display content of the second display member in accordance with detection results of the open/close detection means and the rotation detection means.

### TECHNICAL FIELD

The present invention relates to a mobile communication terminal, an input operation screen control method used for the same, and a program thereof, and particularly related to an input operation of a folding type portable telephone.

### BACKGROUND ART

In a portable telephone relevant to the present invention, various functions are incorporated such as a voice call function, a video telephone function, a camera function, a browser function for the Internet or the like, an e-mail sending and receiving function and a broadcast (TV) receiving function.

Such a kind of portable telephone, in the case where it is a folding type, generally includes a display unit in an upper unit and an operating unit such as a numeric keypad in a lower unit, and used by operating a vertically oriented screen with the numeric keypad.

Further, as a portable telephone relevant to the present invention, a portable telephone is disclosed which supports an upper unit laterally rotatably about an axis and also supports a lower unit laterally rotatably about an axis independently of the upper unit to thereby offer convenience in key operation for a game or the like (e.g., cf. Patent Document 1). Furthermore, as another portable telephone relevant to the present invention, a terminal is disclosed which includes a single rotatable support member that supports a first casing having a display unit and a second casing having an input key or the like rotatably against each other (e.g., cf. Patent Document 2).

### [Patent Document 1]

### Japanese Unexamined Patent Application Publication No. 2006-191632

[Patent Document 2]

### Domestic Re-publication of PCT International Publication for Patent Application, WO2003/056787

### DISCLOSURE OF INVENTION

### Technical Problem

However, in the above-described portable telephone, in the case where it is a folding type, there is a drawback in usability for some functions to be used because the screen is vertically oriented and the operating unit is a numeric keypad, and, it is desired, for example, to eliminate the need for side-to-side scrolling by a change to a horizontally oriented screen for a browser or to improve input operability by a use of a full keypad such as a keyboard for e-mail.

An object of the present invention is thus to solve the above problem and provide a mobile communication terminal, an input operation screen control method used for the same, and a program thereof that enable significant improvement in user's operability.

### Technical Solution

A first mobile communication terminal according to the present invention is a mobile communication terminal made up of an upper unit including a first display member and a first support member having a rotary mechanism that connects the first display member electrically and structurally and a lower unit at least including a second display member, and capable of performing radio communication, which includes rotation detection means that detects a rotation state of the first display member, and control means that controls a display content of the second display member in accordance with a detection result of the rotation detection means.

A second mobile communication terminal according to the present invention is a mobile communication terminal made up of an upper unit including a first display member and a first support member having a rotary mechanism that connects the first display member electrically and structurally and a lower unit including a second display member and a second support member having a rotary mechanism that connects the second display member electrically and structurally, and capable of performing radio communication, which includes rotation detection means that detects a rotation state of the first and the second display member, and control means that controls a display content of the second display member in accordance with a detection result of the rotation detection means.

A first input operation screen control method according to the present invention is an input operation screen control method used in a mobile communication terminal made up of an upper unit including a first display member and a first support member having a rotary mechanism that connects the first display member electrically and structurally and a lower unit at least including a second display member and capable of performing radio communication, in which the mobile communication terminal executes rotation detection processing that detects a rotation state of the first display member, and control processing that controls a display content of the second display member in accordance with a detection result of the rotation detection processing.

A second input operation screen control method according to the present invention is an input operation screen control method used in a mobile communication terminal made up of an upper unit including a first display member and a first support member having a rotary mechanism that connects the first display member electrically and structurally and a lower unit including a second display member and a second support member having a rotary mechanism that connects the second display member electrically and structurally and capable of performing radio communication, in which the mobile communication terminal executes rotation detection processing that detects a rotation state of the first and the second display member, and control processing that controls a display content of the second display member in accordance with a detection result of the rotation detection processing.

A first program according to the present invention is a program to be executed by a computer in a mobile communication terminal made up of an upper unit including a first display member and a first support member having a rotary mechanism that connects the first display member electrically and structurally and a lower unit at least including a second display member and capable of performing radio communication, which includes rotation detection processing that detects a rotation state of the first display member, and control processing that controls a display content of the second display member in accordance with a detection result of the rotation detection processing.

A second program according to the present invention is a program to be executed by a computer in a mobile communication terminal made up of an upper unit including a first display member and a first support member having a rotary mechanism that connects the first display member electrically and structurally and a lower unit including a second display member and a second support member having a rotary mechanism that connects the second display member electrically and structurally and capable of performing radio communication, which includes rotation detection processing that detects a rotation state of the first and the second display member, and control processing that controls a display content of the second display member in accordance with a detection result of the rotation detection processing.

### ADVANTAGEOUS EFFECTS

With the above-described structure and operation, the present invention has an effect of significantly improving user's operability.

### BEST MODE FOR CARRYING OUT THE INVENTION

Embodiments of the present invention are described hereinafter with reference to the drawings. FIG. 1 is a block diagram showing the configuration of a mobile communication terminal according to a first embodiment of the present invention. In FIG. 1, a mobile communication terminal 1 is a folding type mobile information processing device that incorporates communication functions (calling, e-mail sending and receiving, Internet connection etc.) and a television (TV) broadcast receiving function.

The mobile communication terminal 1 includes a radio antenna 11, a broadcast antenna 12, a radio communication unit 13, a broadcast receiving unit 14, a camera unit 15, an audio processing unit 16, a microphone 17, a speaker 18, a display unit 19, a display/input unit 20, a state detection unit 21, an open/close sensor 22, a rotation sensor 23, a speaker unit 24, a storage unit 25 and a control unit 26.

The radio communication unit 13 transmits and receives information by radio to and from a radio base station device, which is not shown, through the radio antenna 11. The broadcast receiving unit 14 receives broadcast signals transmitted from a broadcasting station (a ground station, a satellite etc.), which is not shown, through the broadcast antenna 12, and performs broadcast signal processing on video data, audio data, information data or the like by demodulation of the received signals.

The camera unit 15 performs acquisition (imaging) of images. The audio processing unit 16 performs processing of audio signals input and output through a transmitter unit (the microphone 17) and a receiver unit (the speaker 18). The display unit 19 is composed of a liquid crystal display device or the like, which is not shown, and performs information display output (video signal processing) of images, graphics, characters, symbols and so on.

The display/input unit 20 is a touch panel (touch screen) having both a display function that performs information display output of images, graphics, characters, symbols and so on and a switch function that senses input based on pressure or capacitance.

The state detection unit 21 detects open/close of the upper unit and the lower unit, rotation of the display unit 19 of the upper unit and rotation of the display/input unit 20 of the lower unit by the open/close sensor 22 and the rotation sensor 23 such as a magnetic/hole element or a protruding unit/pushing switch.

The speaker unit 24 performs singing output of musical sound, notification sound or the like. The storage unit 25 stores telephone directory information, sent and received e-mail information, incoming and outgoing call information or content information, application program information, various setting information of the mobile communication terminal 1, programs to be executed in the control unit 26 and so on.

The control unit 26 executes programs stored in the storage unit 25 and controls a calling function, an e-mail function, an Internet (web) connection function, a camera function, a television receiving function, a content playback function, and other functions or components of the terminal.

FIG. 2 and FIG. 3 are views showing rotating motion of a body of the mobile communication terminal 1 according to the first embodiment of the present invention. In FIG. 2 and FIG. 3, the mobile communication terminal 1 is made up of an upper unit 1A having the display unit 19 and a lower unit 1B having the display/input unit (touch panel) 20 which are connected to each other by a hinge unit 1C.

Further, the mobile communication terminal 1 includes not only the display unit 19 but also a first camera unit 15a and the speaker 18 in the upper unit 1A, and may also include a second camera unit (not shown) on the reverse side of a surface having the display unit 19. Furthermore, the mobile communication terminal 1 includes the microphone 17 in addition to the display/input unit (touch panel) 20 in the lower unit 1B.

The upper unit 1A and the lower unit 1B are respectively composed of the display unit 19 and a support unit (not shown), and the display/input unit 20 a support unit (not shown), and the support units electrically and structurally connect the display unit 19 and the display/input unit 20, respectively, and have a rotatable structure.

Specifically, FIG. 2(a) shows an outer appearance when the display unit 19 and the display/input unit 20 are both vertically oriented (in the state where the long sides are vertical in rectangular display areas of the display unit 19 and the display/input unit 20). FIGS. 2(b 1) and (b2) show outer appearances when the display unit 19 is horizontally oriented (in the state where the long sides are horizontal in a rectangular display area) and the display/input unit 20 is vertically oriented.

FIGS. 3(c1) to (c3) show outer appearances when the display unit 19 and the display/input unit 20 are both horizontally oriented. FIG. 3(d) shows an outer appearance when the display unit 19 is vertically oriented and the display/input unit 20 is horizontally oriented. In the following description, the explanation is given by using the key patterns shown in FIG. 2 and FIG. 3 [pattern (a), pattern (b1), pattern (b2), pattern (c1) to (c3) and pattern (d)].

FIG. 4 is a flowchart showing a processing operation of the mobile communication terminal 1 according to the first embodiment of the present invention. A processing operation of the mobile communication terminal 1 is described hereinafter with reference to FIG. 1 to FIG. 4. The processing operation shown in FIG. 4 is implemented by the control unit 26 executing a program stored in the storage unit 25.

If the control unit 26 receives a signal from the state detection unit 21 that has detected output of the open/close sensor 22, it detects whether the form of the mobile communication terminal 1 has changed from a “closed” state to an “open” state based on the signal (Step S1 in FIG. 4).

If the control unit 26 detects that the form of the mobile communication terminal 1 has changed from a “closed” state to an “open” state when the upper unit 1A and the lower unit 1B are both vertically oriented as shown in FIG. 2, it displays a numeric keypad on the display/input unit 20 (Step S2 in FIG. 4) and enables a touch panel related to the keypad (Step S3 in FIG. 4).

In Step S3, an operation for normal outgoing call or incoming call is possible by the touch panel of the display/input unit 20, for example. When performing the outgoing call or incoming call operation, in the state as shown in FIG. 2(a), pressing of a numeric key or an off-hook key displayed on the touch panel of the display/input unit 20 is detected (sensed) in the display/input unit 20, and, by the detection processing, recognition of an operation such as number input and outgoing call processing or incoming call processing are performed in the control unit 26. However, because the outgoing call processing and incoming call processing are known, illustration of such processing steps are omitted in FIG. 4.

Further, in the state of Step S3, if rotation (horizontal displacement) of the display unit 19 of the upper unit 1A or the display/input unit 20 of the lower unit 1B is detected by a signal from the state detection unit 21 that has detected output of the rotation sensor 23 (YES in Step S4 in FIG. 4), and further a function or application such as TV broadcast receiving, e-mail or game is selected by operating a menu key or operating a function key displayed on the touch panel of the display/input unit 20 (YES in Step S8 in FIG. 4), the control unit 26 displays a preset key pattern (setting of the key pattern is described later) or icon pattern on the display/input unit 20 in accordance with the selected function or application and the rotation detection result (Step S6 in FIG. 4) and enables the touch panel related to the keys (icons) (Step S7 in FIG. 4).

Also, in the case where there is no rotation (horizontal displacement) of the upper or lower unit in the above-described Step S4 (NO in Step S4 in FIG. 4) and selection of a function or application is made (YES in Step S5 in FIG. 4), the control unit 26 transitions to the processing of the above-described Step S6.

On the other hand, in the case where rotation (horizontal displacement) of the upper or lower unit is detected (YES in Step S4 in FIG. 4) but there is no selection of a function or application (NO in Step S8 in FIG. 4), the control unit 26 performs vertical/horizontal display conversion of a screen in accordance with the change of the upper unit 1A or the lower unit 1B from a vertically oriented position to a horizontally oriented position (Step S9 in FIG. 4).

In the above-described Step S6, if rotation (horizontally oriented) is detected in the state where an e-mail function is activated, for example, full keyboard (QWERTY keypad) display (or it may be display of a Japanese syllabary keyboard) is made as shown in FIG. 3(c3). Further, if rotation (horizontally oriented) is detected in the state where a game function is activated, a four-direction keypad or the like is displayed as shown in FIG. 3(c1).

FIG. 5 is a view showing an exemplary structure of a table for use in key pattern selection processing (Step S6 in FIG. 4) according to the first embodiment of the present invention. In FIG. 5, a key pattern selection table 25a is configured in such a way that a pattern to be displayed on the touch panel of the display/input unit 20 (the pattern shown in FIG. 2 and FIG. 3) can be retrieved by using the vertically oriented state and the horizontally oriented state of each of the upper unit 1A and the lower unit 1B and a function or application as a key, and it is stored in the storage unit 25. The contents stored in the key pattern selection table 25a can be edited through addition or deletion by a user.

The control unit 26 searches the key pattern selection table 25a on the basis of a detection result of the state detection unit 21 that has detected output of the rotation sensor 23 (the states of the display unit 19 of the upper unit 1A and the display/input unit 20 of the lower unit 1B) and a function or application selected at the point, and displays a pattern corresponding to the states of the display unit 19 of the upper unit 1A and the display/input unit 20 of the lower unit 1B and the function or application at the point on the touch panel of the display/input unit 20.

For example, when the display unit 19 of the upper unit 1A and the display/input unit 20 of the lower unit 1B are both in the vertically oriented state, the control unit 26 displays the pattern (a) of FIG. 2 containing display of a numeric keypad and a direction keypad on the touch panel of the display/input unit 20 if the function or application is video telephone.

Further, when the display unit 19 of the upper unit 1A is in the horizontally oriented state and the display/input unit 20 of the lower unit 1B is in the vertically oriented state, the control unit 26 displays the pattern (b1) of FIG. 2 (the pattern containing display of a numeric keypad and a direction keypad) on the touch panel of the display/input unit 20 if the function or application is Web browser, and displays the pattern (b2) of FIG. 2 on the touch panel of the display/input unit 20 if the function or application is television (TV).

In the pattern (b2) of FIG. 2, of received broadcast information, video data identified by the broadcast receiving unit 14 in FIG. 1 is displayed on the display unit 19 of the upper unit 1A, and data of characters or the like is displayed on a data broadcast display unit of the display/input unit 20 of the lower unit 1B. Further, a channel selection/volume control key and various function keys such as recording and playback are displayed on the display/input unit 20.

Further, when the display unit 19 of the upper unit 1A and the display/input unit 20 of the lower unit 1B are both in the horizontally oriented state, the control unit 26 displays the pattern (c1) of FIG. 3 containing display of a numeric keypad and a direction keypad converted into horizontally oriented display on the touch panel of the display/input unit 20 if the function or application is game [the game in this case is referred to as a game (1)], displays the pattern (c2) of FIG. 3 on the touch panel of the display/input unit 20 if the function or application is camera, and displays the pattern (c3) of FIG. 3 on the touch panel of the display/input unit 20 if the function or application is e-mail. The pattern (c3) of FIG. 3 is display of a QWERTY keypad (full keypad).

The game (1) described above indicates a television game such that the contents of the game involve lateral motion (e.g. side-to-side scrolling) on the display unit 19 of the upper unit 1A, and a user can make operation with both hands on the touch panel of the horizontally oriented display/input unit 20 while watching the horizontally oriented display unit 19 of the upper unit 1A.

In the case of camera, an image of a second camera unit may be displayed on the horizontally oriented display unit 19 of the upper unit 1A and an image of the first camera unit 15a may be displayed on the touch panel of the horizontally oriented display/input unit 20, or those images may be interchanged. Further, an image of the second camera unit may be displayed on the horizontally oriented display unit 19 of the upper unit 1A, and an image captured by the second camera unit may be displayed on the touch panel of the horizontally oriented display/input unit 20 immediately before an image to be displayed on the display unit 19 of the upper unit 1A.

On the other hand, when the display unit 19 of the upper unit 1A is in the vertically oriented state and the display/input unit 20 of the lower unit 1B is in the horizontally oriented state, the control unit 26 displays the pattern (d) of FIG. 3 on the touch panel of the display/input unit 20 if the function or application is game [the game in this case is referred to as a game (2)].

The game (2) described above indicates a television game such that the contents of the game involve longitudinal motion (e.g. up-down scrolling) on the display unit 19 of the upper unit 1A, and a user can make operation with both hands on the touch panel of the horizontally oriented display/input unit 20 of the lower unit 1B while watching the vertically oriented display unit 19 of the upper unit 1A. This case is optimum for the contents of the game in which an object is moving from the upside to the downside in the vertically oriented display unit 19 of the upper unit 1A.

FIG. 6 to FIG. 9 are flowcharts showing key pattern selection processing according to the first embodiment of the present invention. FIG. 6 to FIG. 9 show processing operations in the case where the contents of the above-described key pattern selection table 25a are incorporated as a program. In this case also, addition or deletion is possible by editing the program.

The key pattern selection processing according to the first embodiment of the present invention is described hereinafter with reference to FIG. 1 to FIG. 3 and FIG. 6 to FIG. 9. The processing operations shown in FIG. 6 to FIG. 9 are also implemented by the control unit 26 executing a program stored in the storage unit 25. In FIG. 6 to FIG. 9, a function or application is referred to as a function.

In the case of displaying a preset key pattern or icon pattern on the display/input unit 20 (Step S6 in FIG. 4), the control unit 26 executes the key pattern selection processing shown in FIG. 6 to FIG. 9. In this case, when the display unit 19 of the upper unit 1A is horizontally oriented (Step S11 in FIG. 6) and the display/input unit 20 of the lower unit 1B is vertically oriented (Step S12 in FIG. 6), the control unit 26 determines a currently selected function (Step S13 in FIG. 6).

If the function is Web browser, the control unit 26 selects the pattern (b1) of FIG. 2 and displays it on the touch panel of the display/input unit 20 (Step S14 in FIG. 6), and if the function is television (TV), the control unit 26 selects the pattern (b2) of FIG. 2 and displays it on the touch panel of the display/input unit 20 (Step S15 in FIG. 6).

Next, when the display unit 19 of the upper unit 1A is vertically oriented (Step S11 in FIG. 6) and the display/input unit 20 of the lower unit 1B is horizontally oriented (Step S16 in FIG. 7), the control unit 26 determines a currently selected function (Step S17 in FIG. 7). If the function is game [the game (2) described above], the control unit 26 selects the pattern (d) of FIG. 3 and displays it on the touch panel of the display/input unit 20 (Step S18 in FIG. 7).

When the display unit 19 of the upper unit 1A is horizontally oriented (Step S11 in FIG. 6) and the display/input unit 20 of the lower unit 1B is horizontally oriented (Step S12 in FIG. 6), the control unit 26 determines a currently selected function (Step S19 in FIG. 8). If the function is game [the game (1) described above], the control unit 26 selects the pattern (c1) of FIG. 3 and displays it on the touch panel of the display/input unit 20 (Step S20 in FIG. 8), and if the function is camera, the control unit 26 selects the pattern (c2) of FIG. 3 and displays it on the touch panel of the display/input unit 20 (Step S21 in FIG. 8), and if the function is e-mail, the control unit 26 selects the pattern (c3) of FIG. 3 and displays it on the touch panel of the display/input unit 20 (Step S22 in FIG. 8).

When the display unit 19 of the upper unit 1A is vertically oriented (Step S11 in FIG. 6) and the display/input unit 20 of the lower unit 1B is vertically oriented (Step S16 in FIG. 7), the control unit 26 determines a currently selected function (Step S23 in FIG. 9). If the function is video telephone, the control unit 26 selects the pattern (a) of FIG. 2 and displays it on the touch panel of the display/input unit 20 (Step S24 in FIG. 9).

As described above, in this embodiment, the display unit 19 of the upper unit 1A that mainly performs display output of information is made to be vertically oriented or horizontally oriented display depending on information to be output, and the display/input unit 20 of the lower unit 1B that mainly performs input operation of information is changed to be vertically oriented or horizontally oriented and further a key or icon pattern displayed thereon is changed according to information output to the display unit 19, and it is therefore possible to effectively improve the user's operability.

Although the key pattern selection processing by the key pattern selection table 25a and the key pattern selection processing by the above-described control unit 26 are described in this embodiment, either one of them or combination of them may be performed, without being limited thereto.

FIG. 10 is a view showing rotating motion of a body of a mobile communication terminal according to a second embodiment of the present invention. In FIG. 10, although the basic internal structure of the mobile communication terminal according to the second embodiment of the present invention is similar to that of the mobile communication terminal 1 according to the first embodiment of the present invention shown in FIG. 1, the above-described first embodiment of the present invention is applied to a type in which an upper unit 2A and a lower unit 2B are housed in overlapping fashion [cf. FIG. 10(a)], and the touch panel of the display/input unit 20 of the lower unit 2B becomes exposed for input by sliding the upper unit 2A and the lower unit 2B [cf. FIG. 10(b)].

In this case, the display unit 19 of the upper unit 2A and the display/input unit 20 of the lower unit 2B are supported rotatably about an axis independently of each other [cf. FIG. 10(c)] in this embodiment in order to apply the first embodiment of the present invention. Therefore, the same advantage as in the first embodiment of the present invention can be obtained in this embodiment as well.

FIG. 11 is a view showing rotating motion of a body of a mobile communication terminal according to a third embodiment of the present invention. In FIG. 11, although the basic internal structure of the mobile communication terminal according to the third embodiment of the present invention is similar to that of the mobile communication terminal 1 according to the first embodiment of the present invention shown in FIG. 1, an upper unit 3A and a lower unit 3B respectively support the display unit 19 of the upper unit 3A and the display/input unit 20 of the lower unit 3B rotatably about an axis on the same support member 3C, independently of each other [cf. FIG. 11(a) and (b)]. Therefore, the same advantage as in the first embodiment of the present invention can be obtained in this embodiment as well.

FIG. 12 is a view showing key input processing of a mobile communication terminal according to a fourth embodiment of the present invention, and FIG. 13 is a flowchart showing key input processing of a mobile communication terminal according to the fourth embodiment of the present invention. Although the basic internal structure and external structure of the mobile communication terminal according to the fourth embodiment of the present invention are similar to those of the mobile communication terminal 1 according to the first embodiment of the present invention shown in FIGS. 1 to 3, some features are added to the key input processing.

If the control unit 26 receives a signal from the state detection unit 21 that has detected output of the rotation sensor 23 and thereby detects rotation of the lower unit 1B that performs operation input for transition to the horizontally oriented state (Step S31 in FIG. 13), it transitions to a preset two-hand input operation mode.

At this point, the control unit 26 changes information input when pressing another key depending on presence or absence of pressing of an enter key displayed on the display/input unit 20 (Steps S32 to S35 in FIG. 13). For example, in this embodiment, “hiragana” characters are input in an operation when the enter key is not pressed simultaneously with another key (Steps S33, S35 in FIG. 13), and “katakana” characters are input in an operation when the enter key is pressed simultaneously with another key (cf. FIG. 12) (Steps S33, S34 in FIG. 13).

Alternatively, in this embodiment, “first function (e-mail)” is selected in an operation when the enter key is not pressed simultaneously with another key (Steps S33, S35 in FIG. 13), and “second function (Web browser)” is selected in an operation when the enter key is pressed simultaneously with another key (Steps S33, S34 in FIG. 13). It is thereby possible to improve the input operability by a full keypad such as a keyboard of a personal computer in this embodiment.

As described above, the present invention relates to the mobile communication terminal 1 of the folding type where the upper unit 1A and the lower unit 1B are joined in a freely openable and closeable manner, in which the upper unit 1A and the lower unit 1B are respectively composed of a display unit and a support unit, the support unit has a rotary mechanism that connects the display unit electrically and structurally, vertically oriented or horizontally oriented display is made according to information output to the display unit 19 of the upper unit 1A that mainly performs display output of information, the touch panel of the display/input unit 20 of the lower unit 1B that mainly performs input operation of information is changed to be vertically oriented or horizontally oriented and further a key or icon pattern displayed thereon is changed according to information to be output to the display unit 19, and it is thereby possible to effectively improve the user's operability while maintaining the shape and portability of the mobile communication terminal relevant to the present invention.

Although the upper unit 1A and the lower unit 1B are rotatable independently of each other in the above-described embodiments, the present invention is also applicable to the case where only the upper unit 1A is rotatable and display of the touch panel of the display/input unit 20 of the lower unit 1B is changed.

Further, although the touch panel is used for the display/input unit 20 of the lower unit 1B in the above-described embodiments, the present invention is also applicable to the case where independent keys are arranged in the display/input unit 20 of the lower unit 1B and display of the respective keys is changed.

For example, keys in which display contents are variable (e.g. electronic paper etc.) may be used as the display/input unit 20 of the lower unit 1B. In the case of using electronic paper, the electronic paper may be placed under a key sheet and display of respective key parts of the electronic paper may be controlled to change by the control unit 26. Other than the electronic paper, use of a display member having flexibility such as film liquid crystal is feasible.

Further, each form of the display/input unit 20 of the lower unit 1B described above may be implemented in combination with each of the above-described embodiments, and the present invention is not limited thereto.

This application is based upon and claims the benefit of priority from Japanese patent application No. 2007-206015 filed on Aug. 8, 2007, the disclosure of which is incorporated herein in its entirety by reference.

### BRIEF DESCRIPTION OF DRAWINGS

FIG. 1 is a block diagram showing a configuration of a mobile communication terminal according to a first embodiment of the present invention;

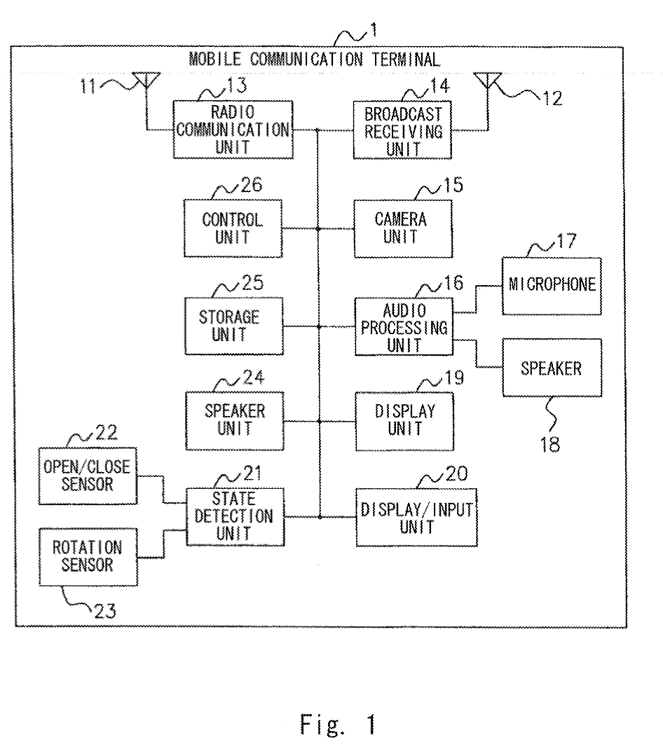

FIG. 2 is a view showing rotating motion of a body of the mobile communication terminal according to the first embodiment of the present invention;

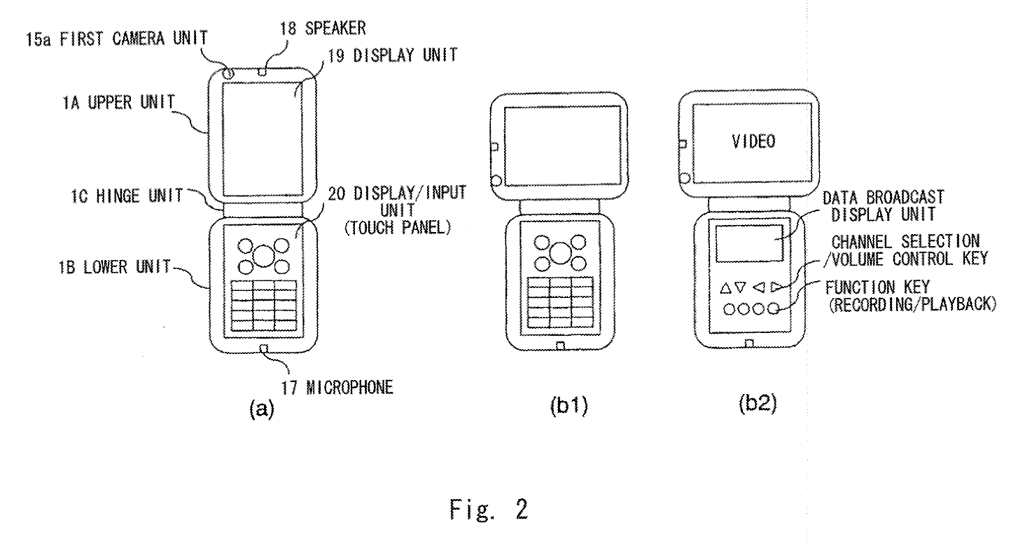

FIG. 3 is a view showing rotating motion of a body of the mobile communication terminal according to the first embodiment of the present invention;

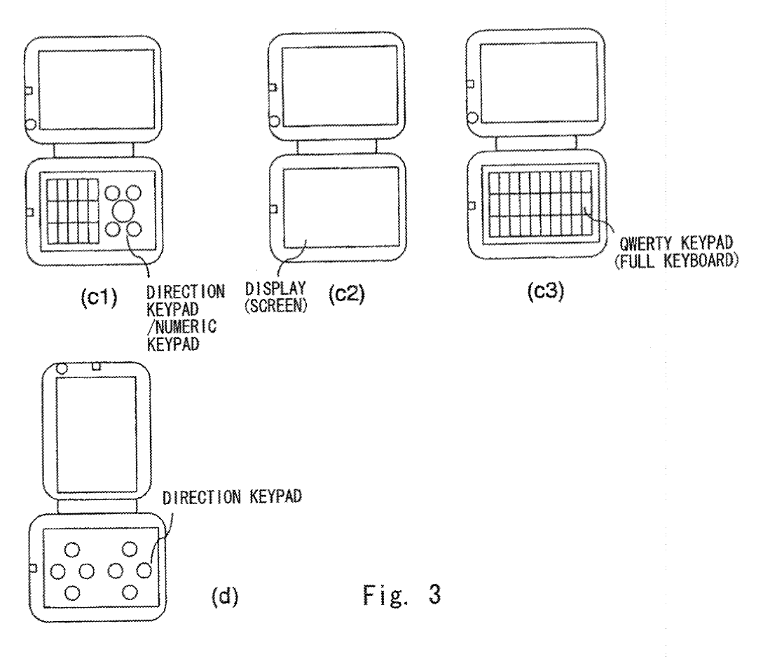

FIG. 4 is a flowchart showing a processing operation of the mobile communication terminal according to the first embodiment of the present invention;

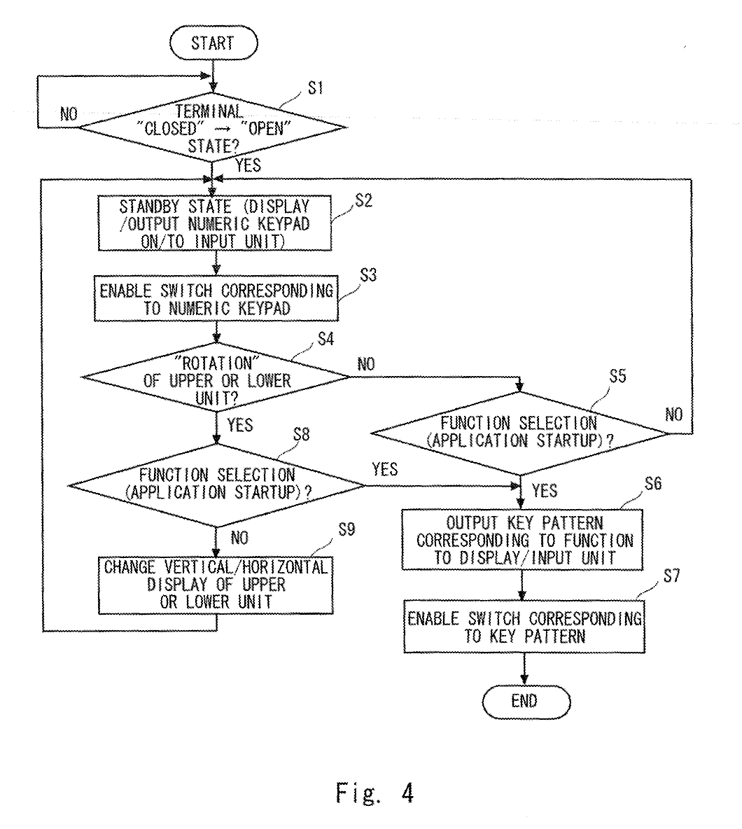

FIG. 5 is a view showing an exemplary structure of a table for use in key pattern selection processing according to the first embodiment of the present invention;

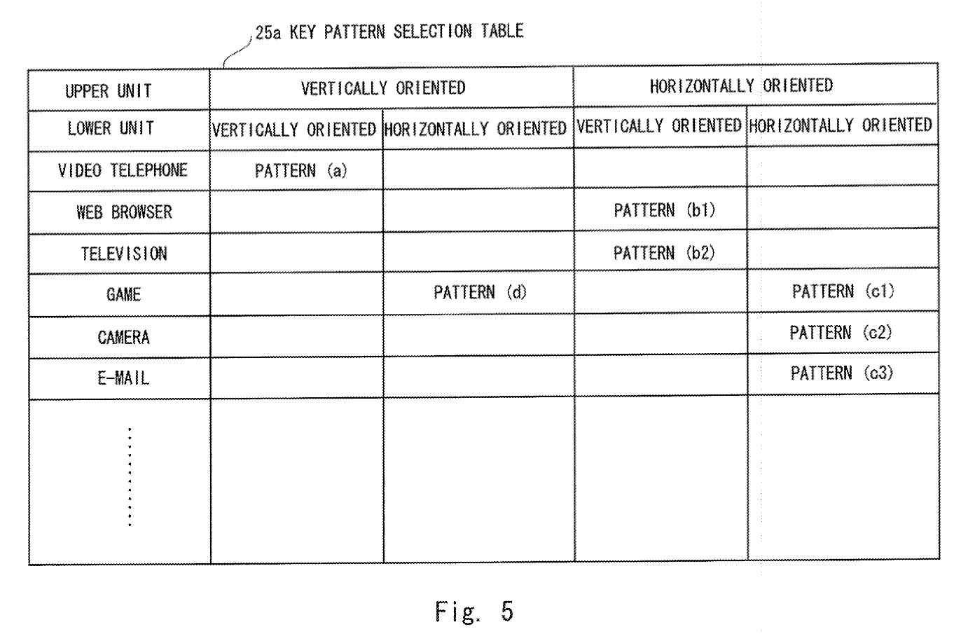

FIG. 6 is a flowchart showing key pattern selection processing according to the first embodiment of the present invention;

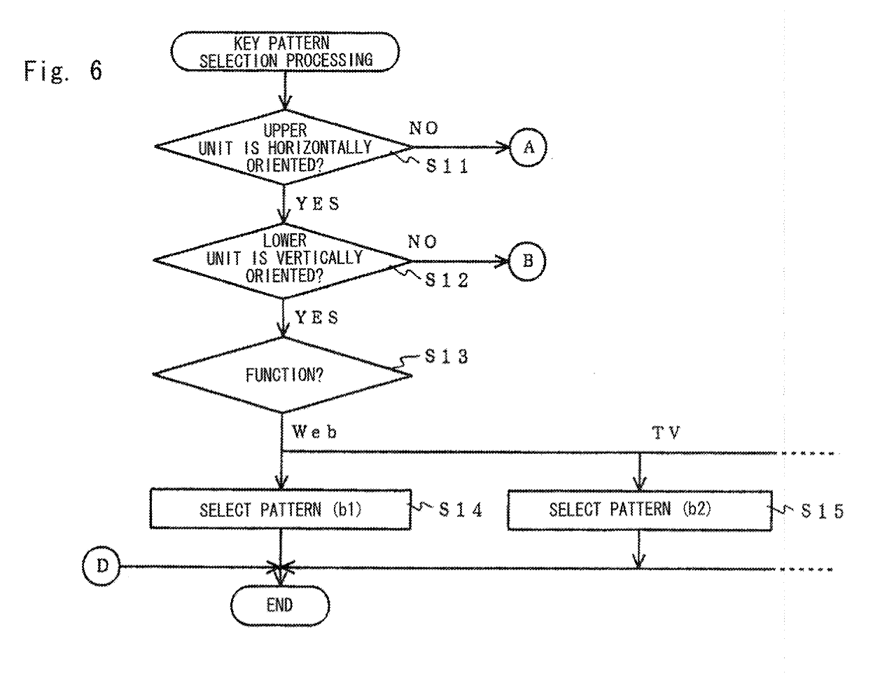

FIG. 7 is a flowchart showing key pattern selection processing according to the first embodiment of the present invention;

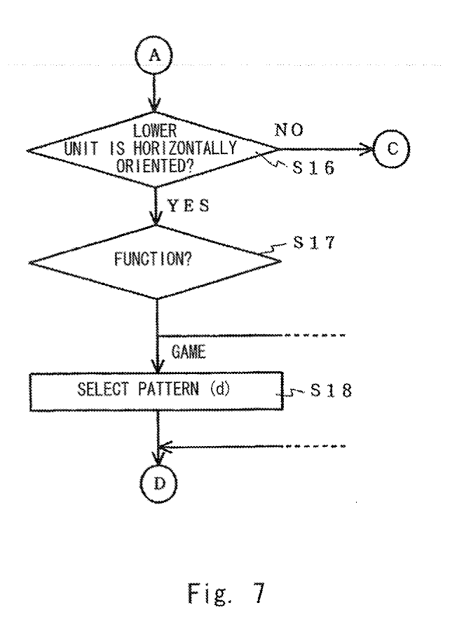

FIG. 8 is a flowchart showing key pattern selection processing according to the first embodiment of the present invention;

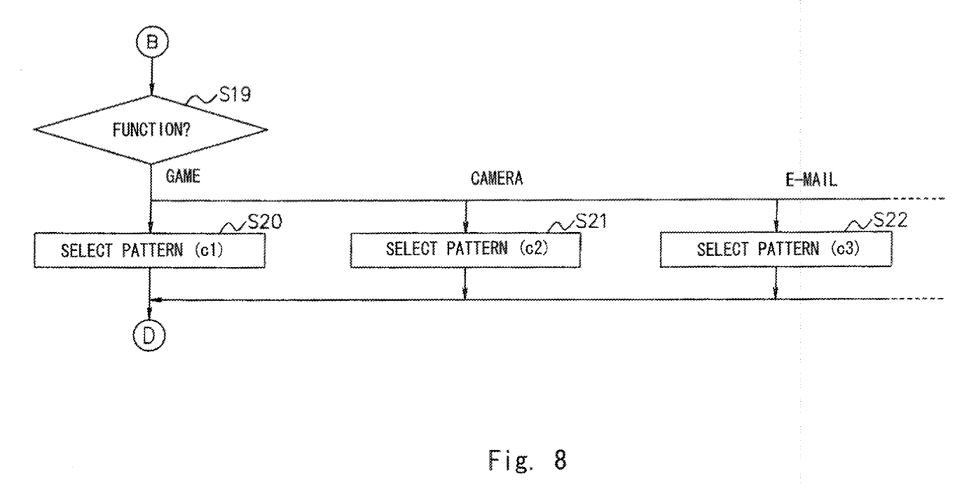

FIG. 9 is a flowchart showing key pattern selection processing according to the first embodiment of the present invention;

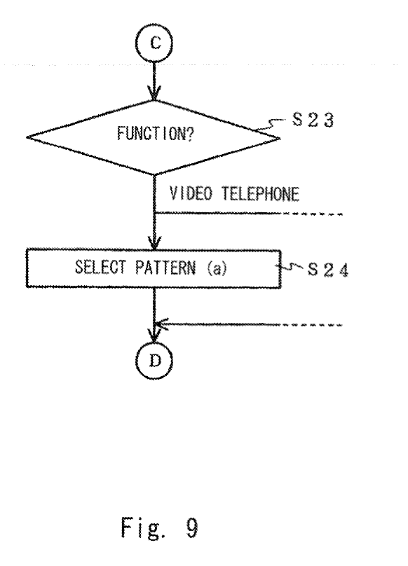

FIG. 10 is a view showing rotating motion of a body of a mobile communication terminal according to a second embodiment of the present invention;

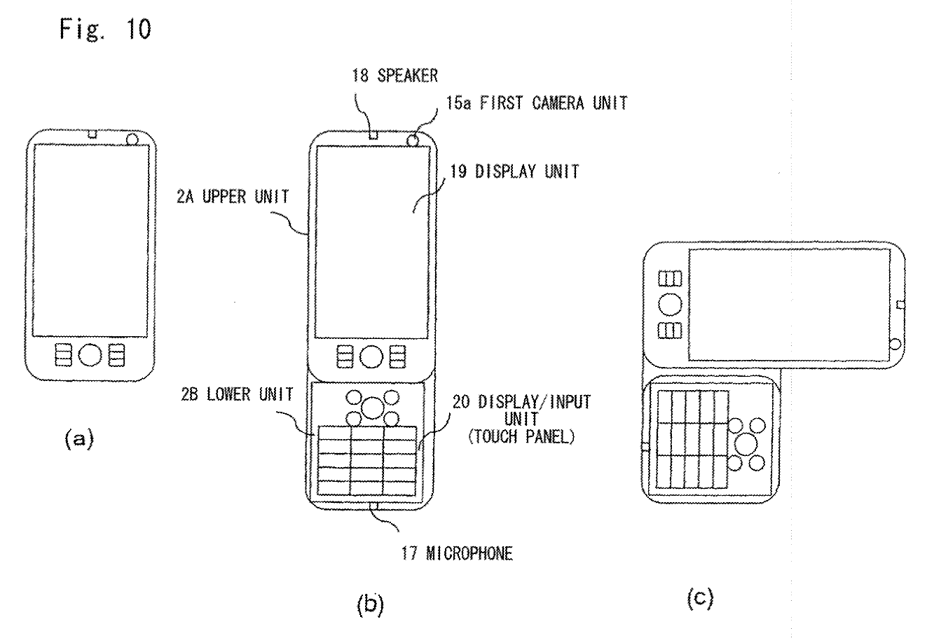

FIG. 11 is a view showing rotating motion of a body of a mobile communication terminal according to a third embodiment of the present invention;

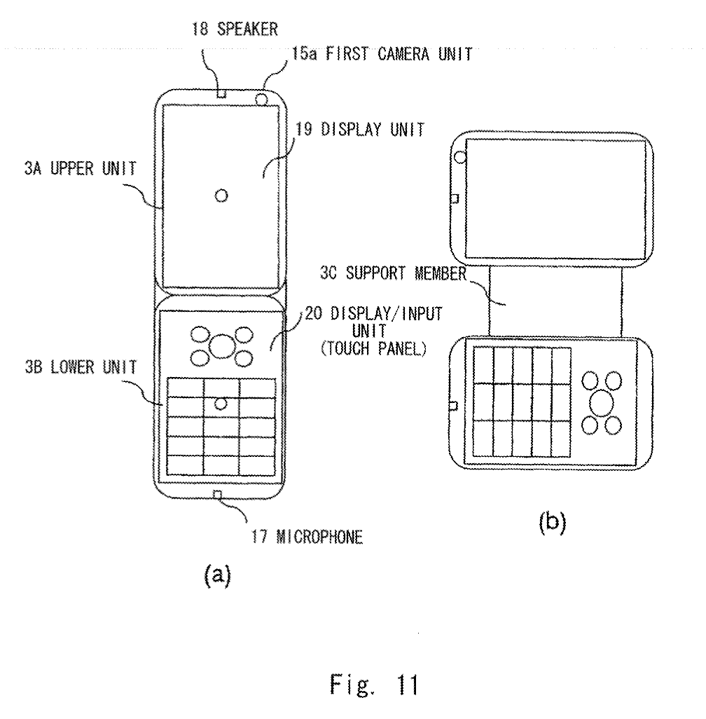

FIG. 12 is a view showing key input processing of the mobile communication terminal according to the fourth embodiment of the present invention; and

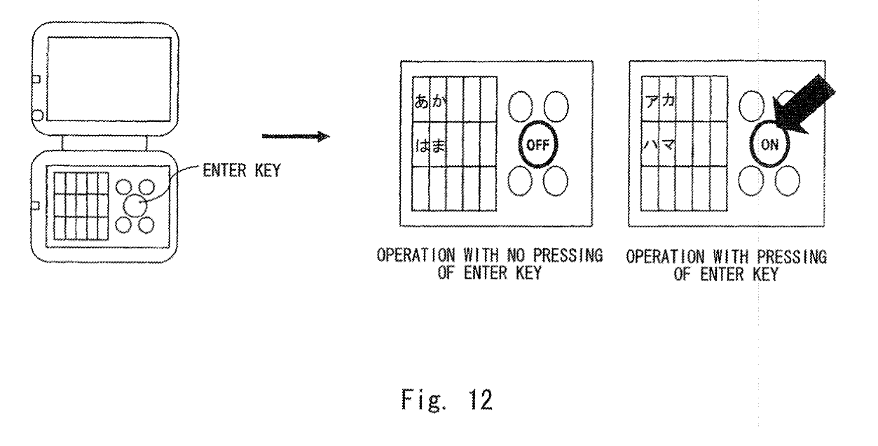

FIG. 13 is a flowchart showing key input processing of the mobile communication terminal according to the fourth embodiment of the present invention.

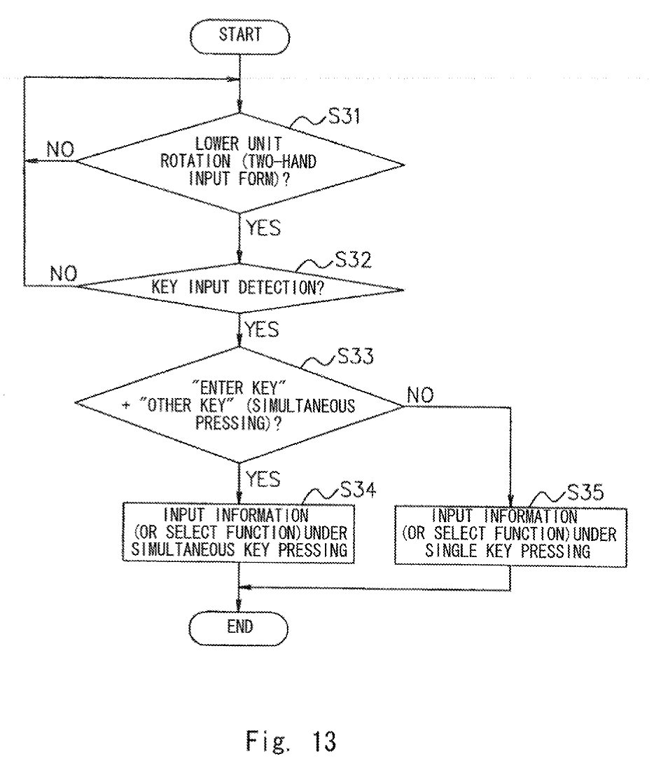

### EXPLANATION OF REFERENCE

1 MOBILE COMMUNICATION TERMINAL
1A, 2A, 3A UPPER UNIT
1B, 2B, 3B LOWER UNIT
1C HINGE UNIT
3C SUPPORT MEMBER
11 RADIO ANTENNA
12 BROADCAST ANTENNA
13 RADIO COMMUNICATION UNIT
14 BROADCAST RECEIVING UNIT
15 CAMERA UNIT
15a FIRST CAMERA UNIT
16 AUDIO PROCESSING UNIT
17 MICROPHONE
18 SPEAKER
19 DISPLAY UNIT
20 DISPLAY/INPUT UNIT
21 STATE DETECTION UNIT
22 OPEN/CLOSE SENSOR
23 ROTATION SENSOR
24 SPEAKER UNIT
25 STORAGE UNIT
25a KEY PATTERN SELECTION TABLE
26 CONTROL UNIT

1. A mobile communication terminal made up of an upper unit including a first display member and a first support member having a rotary mechanism that connects the first display member electrically and structurally and a lower unit at least including a second display member, and capable of performing radio communication, comprising:
a rotation detection unit that detects a rotation state of the first display member; and
a control unit that controls a display content of the second display member in accordance with a detection result of the rotation detection unit.

2. The mobile communication terminal according to claim 1, comprising:
an open/close detection unit that detects an open/close state between the upper unit and the lower unit, wherein
the control unit controls a display content of the second display member in accordance with detection results of the open/close detection unit and the rotation detection unit.

3. The mobile communication terminal according to claim 1, wherein the second display member at least partly includes a switch unit for signal input.

4. The mobile communication terminal according to claim 1, wherein
the first display member mainly performs display output of information and sets screen display to vertically oriented or horizontally oriented display depending on information to be output, and
the second display member is a touch panel that mainly performs input operation of information, and changes screen display to vertically oriented or horizontally oriented display and further changes a key or icon pattern displayed thereon corresponding to information to be displayed on the first display member.

5. The mobile communication terminal according to claim 1, wherein the second display member is placed for each of switch unit for signal input.

6. The mobile communication terminal according to claim 1 wherein
the first display member mainly performs display output of information and sets screen display to vertically oriented or horizontally oriented display depending on information to be output, and
the second display member changes screen display to vertically oriented or horizontally oriented display and further changes a key or icon pattern displayed thereon corresponding to information to be displayed on the first display member.

7. The mobile communication terminal according to claim 3, wherein the control unit controls a display content of the second display member and an enable/disable state of the switch unit in accordance with a detection result of the rotation detection unit and a function selected in the terminal.

8. A mobile communication terminal made up of an upper unit including a first display member and a first support member having a rotary mechanism that connects the first display member electrically and structurally and a lower unit including a second display member and a second support member having a rotary mechanism that connects the second display member electrically and structurally, and capable of performing radio communication, comprising:
a rotation detection unit that detects a rotation state of the first and the second display member; and
a control unit that controls a display content of the second display member in accordance with a detection result of the rotation detection unit.

9. The mobile communication terminal according to claim 8, comprising:
an open/close detection unit that detects an open/close state between the upper unit and the lower unit, wherein
the control unit controls a display content of the second display member in accordance with detection results of the open/close detection unit and the rotation detection unit.

10. The mobile communication terminal according to claim 8, wherein the second display member at least partly includes a switch unit for signal input.

11. The mobile communication terminal according to claim 8, wherein
the first display member mainly performs display output of information and sets screen display to vertically oriented or horizontally oriented display depending on information to be output, and
the second display member is a touch panel that mainly performs input operation of information, and changes screen display to vertically oriented or horizontally oriented display and further changes a key or icon pattern displayed thereon corresponding to information to be displayed on the first display member.

12. The mobile communication terminal according to claim 8, wherein the second display member is placed for each of switch unit for signal input.

13. The mobile communication terminal according to claim 8, wherein
the first display member mainly performs display output of information and sets screen display to vertically oriented or horizontally oriented display depending on information to be output, and
the second display member changes screen display to vertically oriented or horizontally oriented display and further changes a key or icon pattern displayed thereon corresponding to information to be displayed on the first display member.

14. The mobile communication terminal according to claim 10, wherein the control unit controls a display content of the second display member and an enable/disable state of the switch unit in accordance with a detection result of the rotation detection unit and a function selected in the terminal.

15. The mobile communication terminal according to claim 10, wherein the second display member displays at least one of a key and an icon corresponding to the switch unit as the display content.

16. The mobile communication terminal according to claim 10, wherein the second display member displays at least one of a key and an icon corresponding to the switch unit as the display content, and changes the display content depending on presence or absence of simultaneous pressing of a plurality of switch units set in advance in a horizontally oriented state where a longitudinal direction of a display area is horizontal.

17. An input operation screen control method used in a mobile communication terminal made up of an upper unit including a first display member and a first support member having a rotary mechanism that connects the first display member electrically and structurally and a lower unit at least including a second display member and capable of performing radio communication, wherein the mobile communication terminal executes:
rotation detection processing that detects a rotation state of the first display member; and
control processing that controls a display content of the second display member in accordance with a detection result of the rotation detection processing.

18. The input operation screen control method according to claim 17, wherein
the mobile communication terminal executes open/close detection processing that detects an open/close state between the upper unit and the lower unit, and
in the control processing, the mobile communication terminal controls a display content of the second display member in accordance with detection results of the open/close detection processing and the rotation detection processing.

19. The input operation screen control method according to claim 17, wherein the second display member at least partly includes a switch unit for signal input.

20. The input operation screen control method according to claim 17, wherein
the first display member mainly performs display output of information and sets screen display to vertically oriented or horizontally oriented display depending on information to be output, and
the second display member is a touch panel that mainly performs input operation of information, and changes screen display to vertically oriented or horizontally oriented display and further changes a key or icon pattern displayed thereon corresponding to information to be displayed on the first display member.

21. The input operation screen control method according to claim 17, wherein the second display member is placed for each of switch unit for signal input.

22. The input operation screen control method according to claim 17, wherein
the first display member mainly performs display output of information and sets screen display to vertically oriented or horizontally oriented display depending on information to be output, and
the second display member changes screen display to vertically oriented or horizontally oriented display and further changes a key or icon pattern displayed thereon corresponding to information to be displayed on the first display member.

23. The input operation screen control method according to claim 19, wherein, in the control processing, the mobile communication terminal controls a display content of the second display member and an enable/disable state of the switch unit in accordance with a detection result of the rotation detection processing and a function selected in the mobile communication terminal.

24. An input operation screen control method used in a mobile communication terminal made up of an upper unit including a first display member and a first support member having a rotary mechanism that connects the first display member electrically and structurally and a lower unit including a second display member and a second support member having a rotary mechanism that connects the second display member electrically and structurally and capable of performing radio communication, wherein the mobile communication terminal executes:
rotation detection processing that detects a rotation state of the first and the second display member; and
control processing that controls a display content of the second display member in accordance with a detection result of the rotation detection processing.

25. The input operation screen control method according to claim 24, wherein
the mobile communication terminal executes open/close detection processing that detects an open/close state between the upper unit and the lower unit, and
in the control processing, the mobile communication terminal controls a display content of the second display member in accordance with detection results of the open/close detection processing and the rotation detection processing.

26. The input operation screen control method according to claim 24, wherein the second display member at least partly includes a switch unit for signal input.

27. The input operation screen control method according to claim 24, wherein
the first display member mainly performs display output of information and sets screen display to vertically oriented or horizontally oriented display depending on information to be output, and
the second display member is a touch panel that mainly performs input operation of information, and changes screen display to vertically oriented or horizontally oriented display and further changes a key or icon pattern displayed thereon corresponding to information to be displayed on the first display member.

28. The input operation screen control method according to claim 24, wherein the second display member is placed for each of switch unit for signal input.

29. The input operation screen control method according claim 24, wherein
the first display member mainly performs display output of information and sets screen display to vertically oriented or horizontally oriented display depending on information to be output, and
the second display member changes screen display to vertically oriented or horizontally oriented display and further changes a key or icon pattern displayed thereon corresponding to information to be displayed on the first display member.

30. The input operation screen control method according to claim 26, wherein, in the control processing, the mobile communication terminal controls a display content of the second display member and an enable/disable state of the switch unit in accordance with a detection result of the rotation detection and a function selected in the mobile to communication terminal.

31. The input operation screen control method according to claim 26, wherein the second display member displays at least one of a key and an icon corresponding to the switch unit as the display content.

32. The input operation screen control method according to claim 26, wherein the second display member displays at least one of a key and an icon corresponding to the switch means as the display content, and changes the display content depending on presence or absence of simultaneous pressing of a plurality of switch units set in advance in a horizontally oriented state where a longitudinal direction of a display area is horizontal.

33. A Storage medium that stores a program for causing a computer in a mobile communication terminal made up of an upper unit including a first display member and a first support member having a rotary mechanism that connects the first display member electrically and structurally and a lower unit at least including a second display member and capable of performing radio communication, to execute:
rotation detection processing that detects a rotation state of the first display member; and
control processing that controls a display content of the second display member in accordance with a detection result of the rotation detection processing.

34. A Storage medium that stores a program for causing a computer in a mobile communication terminal made up of an upper unit including a first display member and a first support member having a rotary mechanism that connects the first display member electrically and structurally and a lower unit including a second display member and a second support member having a rotary mechanism that connects the second display member electrically and structurally and capable of performing radio communication, to execute:
rotation detection processing that detects a rotation state of the first and the second display member; and
control processing that controls a display content of the second display member in accordance with a detection result of the rotation detection processing.
